(19) United States
(12) Patent Application Publication
(10) Pub. No.: US 2009/0297189 A1
(43) Pub. Date: Dec. 3, 2009

(54) IMAGE FORMING APPARATUS

(75) Inventor: Katsushi SAIKI, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION, Osaka (JP)

(21) Appl. No.: 12/470,610

(22) Filed: May 22, 2009

(30) Foreign Application Priority Data
May 28, 2008 (JP) 2008-138994

(51) Int. Cl. G03G 15/00

(52) U.S. Cl. 399/49; 399/72

(57) ABSTRACT

An image forming apparatus includes an image forming portion and an intermediate transfer portion that has an intermediate transfer member on which a toner image is primarily transferred, the intermediate transfer portion secondarily transfers a toner image on a paper sheet; a position confirmation portion that allows confirmation of a rotational position of the intermediate transfer member; a position detector that outputs a position detection signal at a time of passage of the position confirmation portion; and a control portion which when forming a density-correction pattern image that is a combination of images which are identical to each other in color and different in density, forces the image forming portion to form the density-correction pattern image of a first color by using the position detection signal as a trigger, and forces the image forming portion to form the density-correction pattern images of a second and following colors irrespective of the position detection signal.

This application is based on Japanese Patent Application No. 2008-138994 filed on May 28, 2008, the contents of which are hereby incorporated by reference.

### BACKGROUND OF THE INVENTION

1. Field of the Invention

The present invention relates to an image forming apparatus such as a printer, a copying machine, a facsimile and the like, and more particularly, to an image forming apparatus that forms successively toner images each having one color with a single photoreceptor.

2. Description of Related Art

Conventionally, in an image forming apparatus using toners, a color image is formed by overlapping toner images each having a color. However, because of environmental changes in temperature, humidity and the like, fatigue of a light-sensitive drum(photoreceptor), or toner deterioration, the density of each color toner image formed sometimes deviates from an ideal density. This deviation causes image quality deterioration such as the color of a formed image being different from the document image color and the like. To avoid this, in a color-image forming apparatus, density correction (calibration) of a toner image is performed.

There is a density correction example, in which toner images each having one color for density correction are formed, toner image densities are measured, and it is checked for deviation from an ideal density based on the measurement results. Here, because the toner images for density correction are formed, users cannot perform printing during a time of density correction. Besides, because formation and measurement of a toner image for density correction are repeated a plurality of times in order to confirm a toner-image density after the density correction, users are sometimes kept waiting. In addition, there also are image forming apparatuses in which density correction is carried out when the predetermined number of paper sheets are used for printing from the previous density correction even in sequential printing.

An image forming apparatus that tries to eliminate the disadvantages is disclosed in JP-A-2006-079001. Specifically, in this publication, an image forming apparatus is disclosed, which includes an image forming portion that forms a developer image; a feed portion that feeds the developer image; a density detection portion that detects density of a detection image; a transfer portion that transfers the developer image; an image amount totalization portion that performs density correction based on a detected density from the density detection portion and totalizes the amount of formed images; a determination portion that determines whether or not the image amount exceeds a predetermined amount; and a detection-image generation portion, wherein the detection-image generation portion generates a detection images if an image amount calculated by the determination portion exceeds the predetermined amount, and the image forming portion forms the detection image a plurality of times between developer images transferred to two print mediums. Thus, it is tried to correct density without suspending printing (see JP-A-2006-079001: Claim 1, and paragraph [0007]).

There also are color-image forming apparatuses which have only one light-sensitive drum from the viewpoint of reductions in size, cost and the like (so-called the single-drum type). Because an image forming apparatus of the single-drum type is unable to form different-color toner images on the light-sensitive drum at a time, the image forming apparatus repeats an operation for overlapping toner images each having one color onto an intermediate transfer member, thereby forming one sheet of color image. And, as a single-drum type image forming apparatus, a rotary-type image forming apparatus is sometimes employed, in which development devices each being for one color are housed in a rotation frame, and the rotation frame is suitably rotated to switch the development device for a color to be used.

Besides, in a single-drum type image forming apparatus, it is necessary to rotate the intermediate transfer member a plurality of times to form one sheet of color toner images. However, because image quality is deteriorated if there is a deviation between overlapped toner images, it is necessary to accurately control the overlapping timing. For this purpose, generally, one or more marks are disposed on the intermediate transfer member so as to confirm a rotational position (phase) of the intermediate transfer member. Passage of the mark is detected by a sensor as a position detection signal, and the timing for control of operations such as toner-image formation, overlapping and the like is controlled by using the position detection signal as a reference signal.

Pattern-image formation for density correction in the conventional single-drum type image forming apparatus is explained using FIG. 10. FIG. 10 is a view to explain timings for pattern-image formation for density correction in the conventional single-drum image forming apparatus.

A timing chart in FIG. 10 indicates a position detection signal S. In other words, the timing chat shows that each time an intermediate transfer member makes a revolution, a sensor detects passage of a mark or the like and the position detection signal S changes from high to low. In the conventional single-drum type image forming apparatus, a density-correction pattern image Pa of one color (e.g., a yellow pattern image) is generated by using the position detection signal S based on a change in the output from the sensor as a trigger. And, every time the position detection signal S is detected, the pattern image Pa of each color is formed. According to this method of forming the pattern image Pa, there are advantages that it is possible to improve read accuracy of the pattern image Pa and the control is easy. A changeover time ta at which a rotation frame is rotated is set before the next position detection signal S is detected (e.g., before the intermediate transfer member makes a revolution).

In such method of forming the pattern image Pa during the time of density correction, because the pattern image Pa is formed by using the next position detection signal S as a trigger, as shown in FIG. 10, there is a problem that after the pattern image Pa of one color is formed, a rotation time tb that is used only to rotate the intermediate transfer member and the light-sensitive drum is produced, which is a waste time.

According to the disclosure of JP-A-2006-079001, indeed printing can be continued during the time of density correction and a wait time for users can be eliminated, provided that the image forming apparatus is so-called a tandem-type image forming apparatus that includes a plurality of light-sensitive drums and is able to form a plurality of toner images each having one color at a time between two print mediums. Accordingly, it is difficult to apply the invention disclosed in this publication to a single-drum type image forming apparatus. Besides, considering that in a single-drum type image forming apparatus, the rotation frame is rotated between two print mediums to change the development device (in addition, the distance between two print mediums is becoming shorter because of high-speed printing), it is all the more difficult to apply the invention to a single-drum type image forming apparatus.

### SUMMARY OF THE INVENTION

The present invention has been made to deal with the conventional problems, and it is an object of the present invention to provide an image forming apparatus that successively forms a pattern image of all colors for density correction in a time of density collection irrespective of presence of a position detection signal, thus shortens the time required for density correction, reduces the wait time for users, and improves producibility of the image forming apparatus.

To achieve the object, an image forming apparatus according to an embodiment of the present invention comprises: an image forming portion that includes: a photoreceptor that carries a toner image; an electrification portion that charges the photoreceptor; an exposure portion that forms an electrostatic latent image by performing scan and exposure of the photoreceptor after electrification; and a development portion which develops a plurality of toner images each having one color by supplying each color toner of a plurality of color toners to the electrostatic latent image; an intermediate transfer portion that includes an intermediate transfer member which rotates and on which the toner images each having one color and carried on the photoreceptor are primarily transferred with the toner images being overlapped, the intermediate transfer portion secondarily transfers the toner images on a paper sheet; a position confirmation portion that is disposed on the intermediate transfer member for confirmation of a rotational position of the intermediate transfer member; a position detector that outputs a position detection signal at the time of passage of the position confirmation portion; and a control portion into which the position detection signal is inputted and which controls operation of the image forming apparatus, and when forming a density-correction pattern image that is a combination of images which are identical to each other in color and different in density, forces the image forming portion to form the density-correction pattern image of a first color by using the position detection signal as a trigger, and forces the image forming portion to form the density-correction pattern images of a second and following colors irrespective of the position detection signal.

Conventionally, in an image forming apparatus that has only one photoreceptor and forms a toner image of each color, all density-correction pattern images each having one color are formed by using the position detection signal as a trigger. However, according to this structure, because the density-correction pattern images of the second and following colors are formed irrespective of the position detection signal, the total time required for the formation of the density-correction pattern images of all colors becomes short. Accordingly, the time required for density correction is shortened, and it is possible to shorten the wait time for users and the time the image forming apparatus takes to become ready to print. Besides, producibility of the image forming apparatus also improves. The pattern image is a set of toner images that are different in density but identical in color.

### BRIEF DESCRIPTION OF THE DRAWINGS

FIG. 1 is a schematic sectional view showing a structure of a printer according to a first embodiment.

FIG. 2A is a developed view of an intermediate transfer belt according to the first embodiment, and FIG. 2B shows an example of a position detection sensor.

FIG. 3A shows an example of a pattern image that is formed in a time of density correction of a printer according to the first embodiment, and FIG. 3B shows an example of a density sensor.

FIG. 4 is a block diagram showing an example of a hardware structure of a printer according to the first embodiment.

FIG. 5 is a view to explain timing for formation of a pattern image by a printer according to the first embodiment.

FIG. 6 is a flow chart showing an example of a density-correction control flow in a printer according to the first embodiment.

FIG. 7 is a view to explain timing for formation of a pattern image in a printer according to a second embodiment.

FIG. 8 is a flow chart showing an example of a density-correction control flow in a printer according to the second embodiment.

FIG. 9 is a developed view of an intermediate transfer belt according to a third embodiment.

FIG. 10 is a view to explain timing for formation of a pattern image in a conventional image forming apparatus of the single-drum type.

### DESCRIPTION OF THE PREFERRED EMBODIMENTS

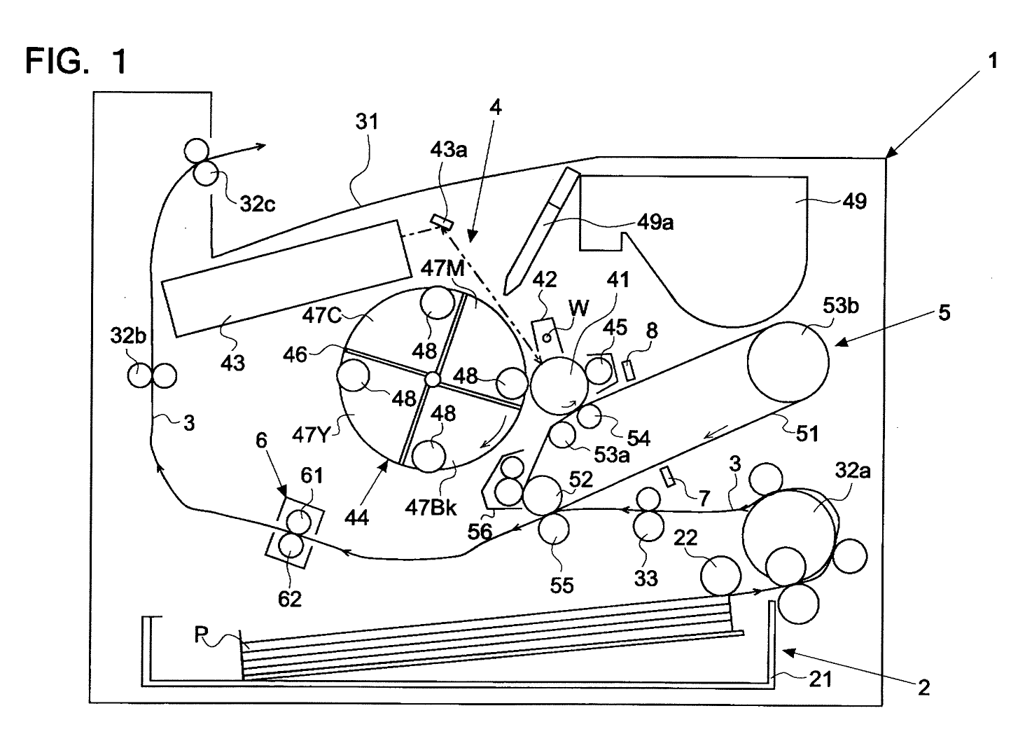

Hereinafter, a first embodiment of the present invention is explained based on FIGS. 1 to 6. In explanation of this embodiment, a rotary-type printer 1 is explained as an example of an image forming apparatus. Each aspect of structures and dispositions explained in the embodiment does not limit the scope of the present invention and is a mere example. Although the details are described later, in the explanation, an intermediate transfer belt 51 is employed as an example of an intermediate transfer member, a position detection sensor 7 is employed as an example of a position detector, and a density sensor 8 is employed as an example of a density detector.

Here, density correction in the present invention means that a toner image of each color is formed for density correction, density of a formed toner image is detected and measured, a check for deviation from an ideal density is performed based on the measurement result, and various setting changes are carried out (calibration).

[Overview of Image Forming Apparatus]

First, using FIG. 1, a printer 1 according to the first embodiment is schematically described. FIG. 1 is a schematic sectional view showing a structure of the printer 1 according to the first embodiment of the present invention.

As shown in FIG. 1, the printer 1 according to the embodiment is composed of a paper supply portion 2, a feed path 3, an image forming portion 4, an intermediate transfer portion 5, a fixing portion 6 and the like.

The paper supply portion 2 is composed of a cassette 21, a paper supply roller 22 and the like. The cassette 21 disposed on a bottom portion of the printer 1 stores various kinds of and various sizes of paper sheets P such as printer paper, recycled paper, OHP sheets, and label paper. The highest paper sheet P comes into contact with the paper supply roller 22, and in the time of printing, the paper supply roller 22 rotates to send out the paper sheets P one after another to the feed path 3.

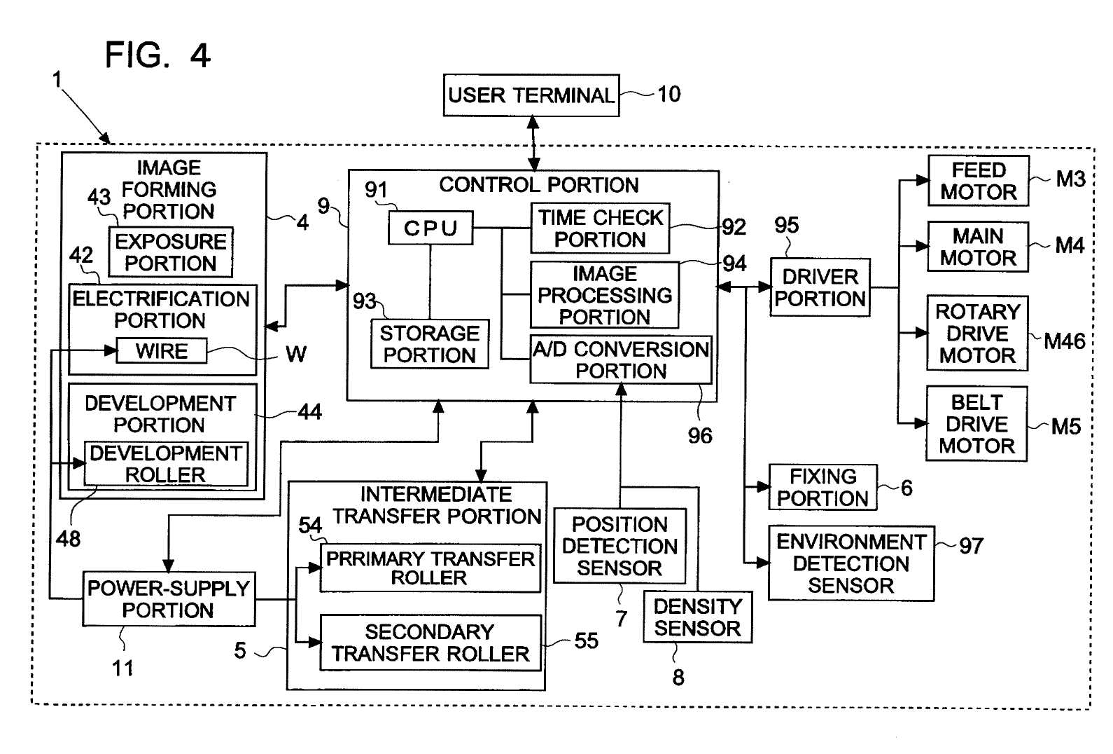

The feed path 3 feeds the paper sheet P in the printer 1 and ejects it on an ejection tray 31. To feed paper sheets, a pair of feed rollers 32 that are rotated by a feed motor M3 (see FIG. 4) are disposed in the feed path 3 (in FIG. 1, indicated by reference numbers 32a, 32b, and 32c in order from the upstream side in the paper feed direction). A pair of resist rollers 33 are disposed in the upstream side with respect to a secondary transfer roller 55. The pair of resist rollers 33 stop temporarily the fed paper sheet P, controls timing for a secondary transfer of a toner image, and carries the paper sheet P to the secondary transfer roller 55.

The image forming portion 4 is composed of a light-sensitive drum 41 (photoreceptor) disposed as an image carrier that carries a toner image, an electrification portion 42, an exposure portion 43, a rotary-type development portion 44, a drum cleaning device 45 and the like that are disposed around the light-sensitive drum 41.

An electrostatic latent image, that is, a toner image is formed on the surface of the light-sensitive drum 41. The light-sensitive drum 41 is disposed roatably in the substantially center portion of the printer 1 and is rotated by a main motor M4 (see FIG. 4). The electrification portion 42 is disposed over the light-sensitive drum 41 and includes therein a wire W mounted along the center-axis direction of the light-sensitive drum 41. The electrification portion 42 is supplied with electricity from a power-supply portion 11 (see FIG. 4), applies a high voltage to the wire W and charges the surface of the light-sensitive drum 41 with corona discharge.

The exposure portion 43 is disposed at an upper portion inside the printer 1, directs laser light to the light-sensitive drum 41 after electrification based on image data and the like transmitted from an external user terminal 10 (see FIG. 4) and the like, performs scan and exposure, and forms an electrostatic latent image. Laser light from the exposure portion 43 is reflected by a reflection mirror 43a and directed to the light-sensitive drum 41 (laser light is indicated by a one-bar-two-dot line).

The rotary-type development portion 44 supplies a plurality of color toners to an electrostatic latent image and develops a multi-colored toner image. In FIG. 1, the development portion 44 is disposed next to the left side of the light-sensitive drum 41 and includes a rotation frame 46. The rotation frame 46 houses four development units 47. Specifically, the rotation frame 46 is equipped with four development units in total: a development unit 47Bk for forming a black toner image; a development unit 47Y for forming a yellow toner image; a development unit 47C for forming a cyan toner image; and a development unit 47M for forming a magenta toner image. Accordingly, the printer 1 in the embodiment forms a color image using four color toners of black, yellow, cyan and magenta. Because the development units 47 have the same structure, the letters Bk, Y, C and M are omitted, with the exception of special explanation.

Each development unit 47 stores each color toner and charges the toner to a predetermined electric potential. Each development unit 47 is equipped with a development roller 48 that carries a toner thin layer. A plurality of containers 49 each storing each color toner are disposed in the direction perpendicular to the paper surface of FIG. 1 (only one visible in FIG. 1). To supply a toner to each development unit 47, a supply tube 49a that is elastic and inserted into each development unit 47 when stretched is connected to each container 49.

The rotation frame 46 is rotated by a rotary drive motor M46 (see FIG. 4), so that the development unit 47 that stores a color toner used in the time of development is forced to face the light-sensitive drum 41. Here, each development roller 48 faces the light-sensitive drum 41 with a gap left therebetween, and a superposed voltage (hereinafter, called a “development bias”) including a DC voltage and an AC voltage is applied to each development roller 48 in the time of developing an electrostatic latent image. A charged toner flies to the light-sensitive drum 41 with the aid of electrostatic force. Thus, an electrostatic latent image is developed with the toner, thereby a toner image is formed. As described above, in the time of forming a color image, the development portion 44 rotates the rotation frame 46, changes the current development unit 47 to another development unit 47 to be used, so that toner images each having one color are formed on the light-sensitive drum 41 one after another.

The drum cleaning device 45 is disposed on the right side of the light-sensitive drum 41 in FIG. 1 and removes toners remaining and matters adhering on the light-sensitive drum 41.

The intermediate transfer portion 5 is composed of: an intermediate transfer belt 51 (which corresponds to an intermediate transfer member) to which toner images carried on the light-sensitive drum 41 and each having one color are primarily transferred successively; a drive roller 52 which is used to mount and rotate the intermediate transfer belt 51 thereon; tension rollers 53a and 53b; a primary transfer roller 54 that faces the light-sensitive drum 41 and is pressurized toward the light-sensitive drum 41 with the intermediate belt 51 interposed therebetween; a secondary transfer roller 55 that faces the drive roller 52 and is pressurized toward the drive roller 52 with the intermediate transfer belt 51 interposed therebetween; and a belt cleaning device 56 that cleans the intermediate transfer belt 51. Drive force of a belt drive motor M5 (see FIG. 4) is imparted to the drive roller 52, so that the drive roller 52 rotates and the intermediate transfer belt 51 mounted rotates (makes revolutions).

Next, a toner-image transfer process is explained. First, in the time of a primary transfer, a voltage (which has a reversed polarity to a charged polarity of the toner) is applied to the primary transfer roller 54, and a toner image is transferred to the intermediate transfer belt 51. In the time of forming a color image, the intermediate transfer belt 51 makes one revolution for each-color toner image (four revolutions in total), and eventually all the toner images each having one color are overlapped into one toner image on the intermediate transfer belt 51. After completion of the primary transfer, the paper sheet P is carried in synchronization with the toner image on the intermediate transfer belt 51, goes into the nip between the secondary transfer roller 55 and the intermediate transfer belt 51, then a voltage is applied to the secondary transfer roller 55. Thus, the toner image is secondarily transferred to the paper sheet P.

The fixing portion 6 melts and fixes the toner image on the paper sheet P. The fixing portion 6 in the embodiment includes a heat roller 61 that incorporates a heater, and a pressurization roller 62 that is pressurized to the heat roller 61. The paper sheet P goes between both rollers and the paper sheet P is heated and pressurized, so that a toner image is fixed on the paper sheet P.

[Position Detection of Intermediate Transfer Member]

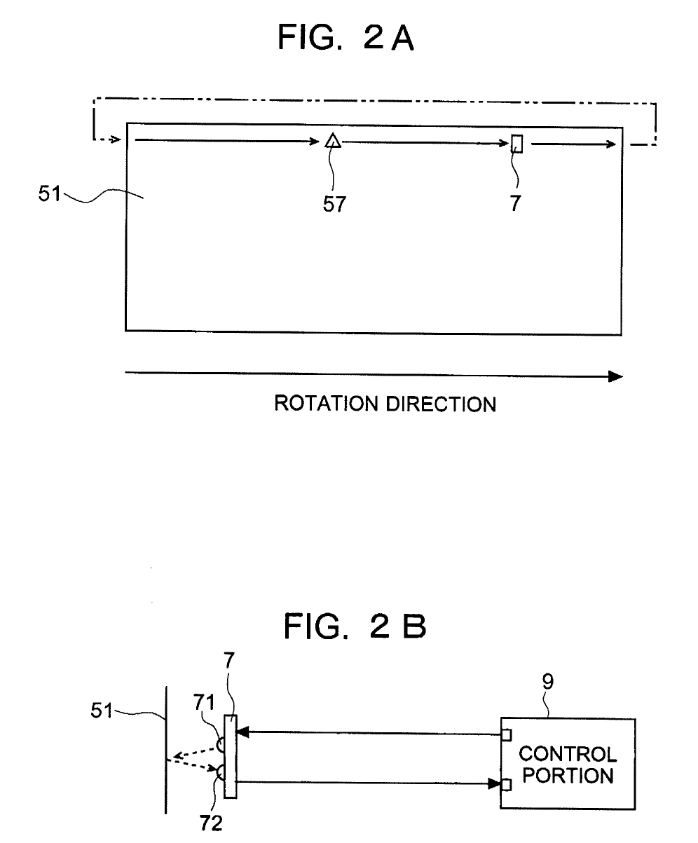

Next, Position detection of the intermediate transfer belt 51 according to the first embodiment of the present invention is explained. FIG. 2A is a developed view of the intermediate transfer belt 51 according to the first embodiment of the present invention, and FIG. 2B shows an example of the position detection sensor 7.

In FIG. 2A, a surface of the intermediate transfer belt 51 is shown. A position confirmation portion 57 is disposed on an edge portion of the intermediate transfer belt 51. The position confirmation portion 57 is, for example, a hole, a protrusion, a cutout, a reflection sheet or the like, that is, a mark that is used to detect and confirm a rotational position (phase) of the intermediate transfer belt 51. In the embodiment, one mark is disposed on the intermediate transfer belt 51. As represented by a solid-line arrow, the position confirmation portion 57 moves as the intermediate transfer belt 51 rotates. As shown in FIG. 2A, the position detection sensor 7 (which corresponds to the position detector) is disposed at a position over the movement path of the position confirmation portion 57. In other words, passage of the position confirmation portion 57 is detected once for one revolution of the intermediate transfer belt 51. The number of position confirmation portions 57 is not limited to one, and a plurality of position confirmation portions 57 may be disposed considering the circumferential length of the intermediate transfer belt 51. The position confirmation portion 57 needs only to be so formed as to output a value different from a value that the position detection sensor 7 outputs when the position detection sensor 7 reads the intermediate transfer belt 51, and there is no special limit on the position confirmation portion 57.

As shown in FIG. 2B, to detect passage of the position confirmation portion 57, the position detection sensor 7 includes a light emitting portion 71 and a light receiving portion 72. The light emitting portion 71 uses a light emitting device such as an LED and the like to direct light to the surface of the intermediate transfer belt 51, and the light receiving portion that includes a light receiving device such as a photodiode and the like receives reflected light from the intermediate transfer belt 51. When the position confirmation portion 57 passes through the position detection sensor 7, the output from the position detection sensor 7 changes. In other words, because the intermediate transfer belt 51 and the position confirmation portion 57 are different from each other in reflectance and the like, the light amount received by the position detection sensor 7 changes (the light amount received by the light receiving device is nearly zero for a hole and a cutout, and greatly changes for a protrusion and a reflection sheet and the like).

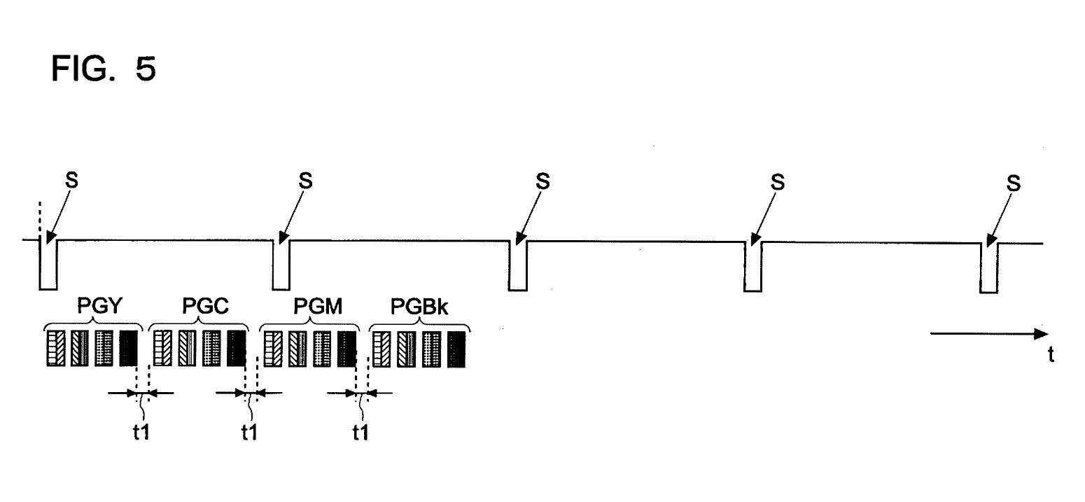

In the printer 1 according to the embodiment, a change in the output from the light receiving portion 72 of the position detection sensor 7 due to the passage of the position confirmation portion 57 is used as the position detection signal S (see FIG. 5). In other words, the position detection sensor 7 outputs the position detection signal S when the position confirmation portion 57 passes. In the printer 1 according to the embodiment, the position detection signal S which is an exact result obtained by detecting a rotational position (phase) of the intermediate transfer belt 51 is used as a reference signal for image-forming control.

For example, in the time of printing, the position detection signal S is used to control the timings of start and end of operations of the electrification portion 42, the exposure portion 43, the development portion 44, the pairs of resist rollers 33 and the like, voltage application to the primary transfer roller 54 and the secondary transfer roller 55 and the like. Besides, for example, the start and end of rotation of the rotation frame 46 of the development portion 44 are also controlled for a changeover of the development unit 47. Especially, in the printer 1 according to the embodiment, when forming a toner image, because only one light-sensitive drum 41 is used, it is necessary to rotate the intermediate transfer belt 51 four times to overlap the four color toner images. Performing the control to overlap the toner images each having one color by using the position detection signal S as the reference signal allows accurate overlapping of the toner images and transfer of the toner images to the paper sheet P.

[Overview of Density Correction]

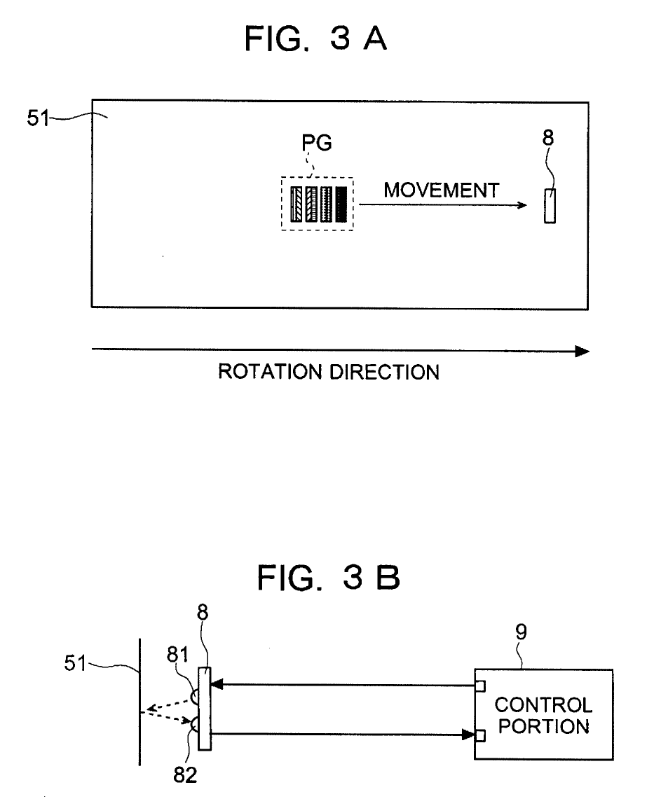

Next, density correction in the printer 1 according to the first embodiment of the present invention is schematically described based on FIG. 3. FIG. 3A shows an example of the pattern image PG that is formed in a time of density correction in the printer 1 according to the first embodiment of the present invention, and FIG. 3B shows an example of the density sensor 8.

For example, because of dust and fatigue of the light-sensitive drum 41, deterioration of the toner stored in each development unit 47, changes in environmental conditions such as temperature, humidity and the like, density of a formed image sometimes deviates from an ideal density. The density deviation brings degradation and the like in document-image reproducibility and causes deterioration in image quality. To eliminate the problems, in the printer 1 according to the embodiment, density correction is carried out at the following timings: the timing for turning on the power supply; the timing for returning from a power-saving mode; and the timing the predetermined number of paper sheets are used for printing from the previous density correction. In other words, density calibration of the printer 1 is implemented.

As shown in FIG. 3A, in the time of density correction, the image forming portion 4 in the embodiment forms the pattern image PG (in FIG. 3, only a one-color pattern image is shown). The pattern image PG is a set of toner images that are different in density but identical in color (eight images in the embodiment). And, in the time of density correction, the pattern images PG each of which is a set of images that are different in density but identical in color are formed for each color. The density of each image of a pattern image PG is suitably set, for example, an image is formed at a density of 10%; another image is formed at a density of 50% or 60%. In other words, eight typical points are extracted from the whole density range, and the images that respectively have the densities of the typical points are arranged in a row, thereby the pattern image PG in the embodiment is formed. To detect and measure density of the pattern image PG, the density sensor 8 (which corresponds to the density detector) is disposed at a position where the density sensor 8 faces the intermediate transfer belt 51 and is able to read the pattern image PG that is transferred and moved (see FIG. 1).

Here, as shown in FIG. 3A, to read the pattern image PG, the density sensor 8 is disposed at a suitable position such as a position over the intermediate transfer belt 51 and the like. And, as shown in FIG. 3B, the density sensor 8 includes a light emitting portion 81 and a light receiving portion 82. The light emitting portion 81 directs light to a surface of the intermediate transfer belt 51 and the light receiving portion 82 receives reflected light from the intermediate transfer belt 51. The light emitting portion 81 includes, for example, a light emitting device such as an LED, a laser diode and the like, and the light receiving portion 82 includes a light receiving device such as a photodiode and a phototransistor that receive light and output an electric current (voltage).

The output from the light receiving portion 82 at the time the light receiving portion 82 receives reflected light from the surface of the intermediate transfer belt 51 is different from the output at the time the light receiving portion 82 receives reflected light from a toner image. Even when the light receiving portion 82 receives reflected light from a toner image, the output changes depending on differences in light absorption, reflectance and the like and depending on density of a read toner image. For example, because of differences in light absorption amount and the like, the output from the light receiving portion 82 derived from a black solid toner image can be smaller than the output from the light receiving portion 82 derived from a black half-tone toner image.

As described above, there is a correlation between the output from the light receiving portion 82 and the density and color of a toner image. The output from the light receiving portion 82 is inputted into the control portion 9 (see FIG. 4) described later. Output voltages values from the density sensor 8 that are obtained when the density sensor 8 reads pattern images PG of respective colors that are formed at ideal densities are measured in advance, and the density values (e.g., represented by 8 bits, that is, values indicating 256 gradations) equivalent to the output voltage values are stored in a storage portion 93. A CPU 91 compares a density value equivalent to an output voltage value that is obtained when an each-density toner image of a pattern image actually formed is read with the density of the ideal-density toner image, thereby the current density of each-density toner image is able to be detected. In other words, in the time of density correction, the control portion 9 compares a toner-image density value calculated based on an output value from the density sensor 8 that is measured by reading a pattern image PG with the ideal density value.

[Printer Hardware Structure]

Next, a hardware structure of the printer 1 according to the first embodiment of the present invention is explained based on FIG. 4. FIG. 4 is a block diagram showing an example of a hardware structure of the printer 1 according the first embodiment of the present invention.

As shown in FIG. 4, the control portion 9 is disposed, into which the position detection signal S is inputted to control operations of each portion and member of the printer 1 in the embodiment. The control portion 9 is connected to portions such as the image forming portion 4, the intermediate transfer portion 5 and the like and carries out various kinds of control.

For example, the control portion 9 is equipped with the CPU 91, a time check potion 92, the storage portion 93, an image processing portion 94 and the like. The CPU 91 is the central processing unit that transmits control signals to each portion of the printer 1 based on control programs and data, and receives signals from each portion to perform various operations and control and the like. The time check portion 92 checks various times necessary for control of the printer 1. For example, after the position detection signal S is detected, the time check portion 92 checks the time to a rotation start of the rotation frame 46, the time to formation of an electrostatic latent image, the time to implementation of development of a toner image, and the like. The CPU 91 may have the time check function.

The storage portion 93 is constituted by a combination of a volatile storage device and a non-volatile storage device such as a ROM (Read Only Memory), a RAM (Random Access Memory), a HDD (Hard Disk Drive), a flash ROM and the like. The storage portion 93 stores various data such as the control programs, control data, image data, setting data and the like. In the present invention, the storage portion 93 stores density-correction programs and image data of the pattern image PG, and in the time of density correction, the CPU 91 implements various kinds of operation and control based on the density-correction programs and the image data of the pattern image PG.

The user terminal 10 is connected to the printer 1 directly or over a network. The image processing portion 94 applies various kinds of processing such as density adjustment, enlargement, reduction and the like to image data of an image to be printed that are transmitted to the printer 1 from the user terminal 10. After the image processing, the image data are outputted to the exposure portion 43 and used to form an electrostatic image.

A driver portion 95 that is composed of an IC and a switch and the like which control on/off and the like of various motors is connected to the control portion 9. For example, a feed motor M3, the main motor M4, the rotary drive motor M46, the belt drive motor M5 and the like are connected to the driver portion 95. The control portion 9 outputs an instruction to the driver portion 95, and the driver portion 95 controls operations of various motors. For example, in the time of density correction, because only the formation of the pattern image PG is enough and the paper-sheet feed is unnecessary, the control portion 9 outputs instructions to stop the feed motor M3 and to force the main motor M4, the rotary drive motor M46, the belt drive motor M5 to operate.

Besides, the position detection sensor 7 is connected to the control portion 9, and the position detection signal S is inputted into the control portion 9 (the CPU 91). Thus, the rotational position (phase) of the intermediate transfer belt 51 is detected, and the rotation of the rotation frame 46 and the various timings for formation of a toner image are controlled, thereby the timings for start and end of various operations are controlled.

Also, the output from the density sensor 8 is inputted into the control portion 9, that is, the output value from the density sensor 8 is inputted into an A/D conversion portion 96. The A/D conversion portion 96 applies A/D conversion to the output from the density sensor 8 and outputs an A/D-converted value, and the CPU 91 calculates a density value of a formed toner image. If the CPU 91 has the A/D conversion function, the A/D conversion portion 96 may not be disposed.

Because the pattern image PG of one color is a combination of images that have different densities (in the embodiment, eight images, see FIG. 3), eight density values are obtained from the pattern image PG of one color. Each density value obtained from reading and measurement of the output from the density sensor 8 is compared with the density value obtained by forming each image at the ideal density, thus a deviation in density is given.

The density of a formed image sometimes varies if environmental conditions such as temperature, humidity and the like greatly change. To deal with this problem, as shown in FIG. 4, an approach may be employed, in which an environment detection sensor 97 such as a temperature sensor, a humidity sensor and the like is disposed in the printer 1; an output from this environment detection sensor 97 is inputted into the control portion 9 to detect a dramatic change in environmental conditions, and density correction is carried out.

Next, a specific method of implementing density adjustment in the time of printing is explained using FIG. 4. As shown in FIG. 4, the control portion 9 controls each portion of the printer 1, and for this purpose, the control portion 9 is also connected to the image forming portion 4 and the intermediate transfer portion 5. Also, the control portion 9 is connected to the power-supply portion 11 that is suitably disposed in the printer 1. The power-supply portion 11 is connected to a commercial power supply and performs rectifying, boosting voltage, dropping voltage and the like.

The power-supply portion 11 generates various predetermined voltages such as a high voltage for discharge from the wire W of the electrification portion 42, a development bias applied to the development roller 48, voltages applied to the primary transfer roller 54 and the secondary transfer roller 55, and supplies the voltages to each portion.

Here, it is possible to vary the density of a formed image by changing the values of the voltages which are respectively applied to the wire W of the electrification portion 42, the development portion 48, the primary transfer roller 54 and the secondary transfer roller 55. For example, if the voltage value applied to the wire W is changed, the charge amount of the light-sensitive drum 41, that is, the charge potential of the light-sensitive drum 41 varies, and the amount of toner that flies to the light-sensitive drum 41 varies. Also, if the development bias to the development roller 48 is changed, the amount of toner that flies to the light-sensitive drum 41 varies. For example, if an AC voltage in the development bias is made large, the fly distance of the toner becomes long, the amount of flying toner increases, and the density of a formed image becomes high. If the voltages applied to the primary transfer roller 54 and the secondary transfer roller 55 are changed, the amount of toner that is transferred to the intermediate transfer belt 51 and a paper sheet varies.

Thus, for example, if the density obtained by measuring the pattern image PG is higher or lower than an ideal density as a whole, to eliminate the deviation, the control portion 9 changes parameters of the voltages that are applied to the wire W of the power-supply portion 11, the development roller 48, the primary transfer roller 54, and the secondary transfer roller 55, thereby it is possible to adjust the density to be thick or thin in the time of printing.

Considering the structure of the power-supply portion 11, it is possible to freely decide to change some or all of the voltages applied to the wire W, the development roller 48, the primary transfer roller 54, and the secondary transfer roller 55. To make a decision on how much to change an applied voltage for a deviation between an actual density and an ideal density, an approach may be employed, in which based on data obtained through experiences such as experiments and the like, parameters to be changed are stored in the storage portion 93 in the form of a table, and based on the table, it is decided which applied voltages should be changed and how much the applied voltages should be changed.

Because the printer 1 in the embodiment includes the image processing portion 94 that processes image data, for example, if a deviation between a specific density of an actual image and an ideal density is large, the image processing portion 94 may adjust the pixel value corresponding to the specific density and being contained in the image data, and adjust the density in the time of printing so as to make the density of a formed image become close to the ideal density.

[Formation of Pattern Image PG]

Next, based on FIG. 5, a specific method of forming the pattern image PG in the printer 1 according to the first embodiment of the present invention is explained. FIG. 5 is a view to explain timing for formation of the pattern image PG in the printer 1 according to the first embodiment of the present invention.

In FIG. 5, each pattern image PG is a combination of images that are different from each other in density (in FIG. 5, eight images). In FIG. 5, a yellow patter image PG is indicated by PGY, a cyan pattern image PG is indicated by PGC, a magenta pattern image PG is indicated by PGM, and a black pattern image PG is indicated by PGBk. A line above the pattern images PG indicates a timing chart of the position detection signal S.

In the printer 1 in the embodiment, although the first color pattern image PGY is formed using the position detection signal S as a trigger (reference), there is a feature that the second and following pattern images PG (PGC, PGM, and PGBk) are formed irrespective of the position detection signal S. However, because the time for changing the current development unit 47 to another development unit 47 by rotating the rotation frame 46 is necessary, a changeover time t1 for changing the development unit 47 is secured between each pattern image PG.

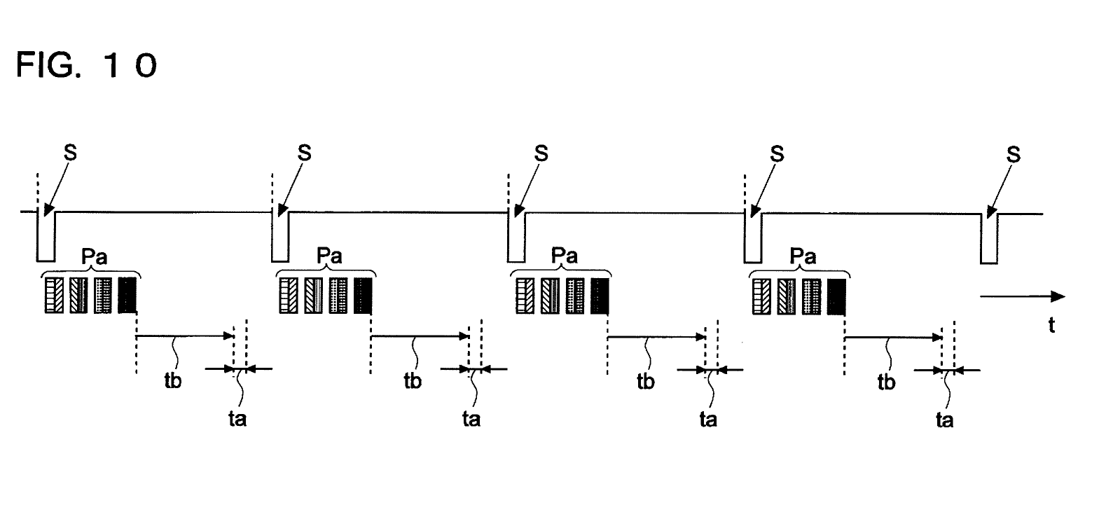

Because the pattern images PG are formed as in the foregoing description, the total formation time for all the color pattern images PG is dramatically shortened compared with the conventional single-drum type image forming apparatus shown in FIG. 10. Although it depends on the circumferential length of the intermediate transfer belt 51, the time required for the formation of all the color pattern images PG is decreased to about ½ to ⅓ the conventional time in principle.

[Density Correction Control]

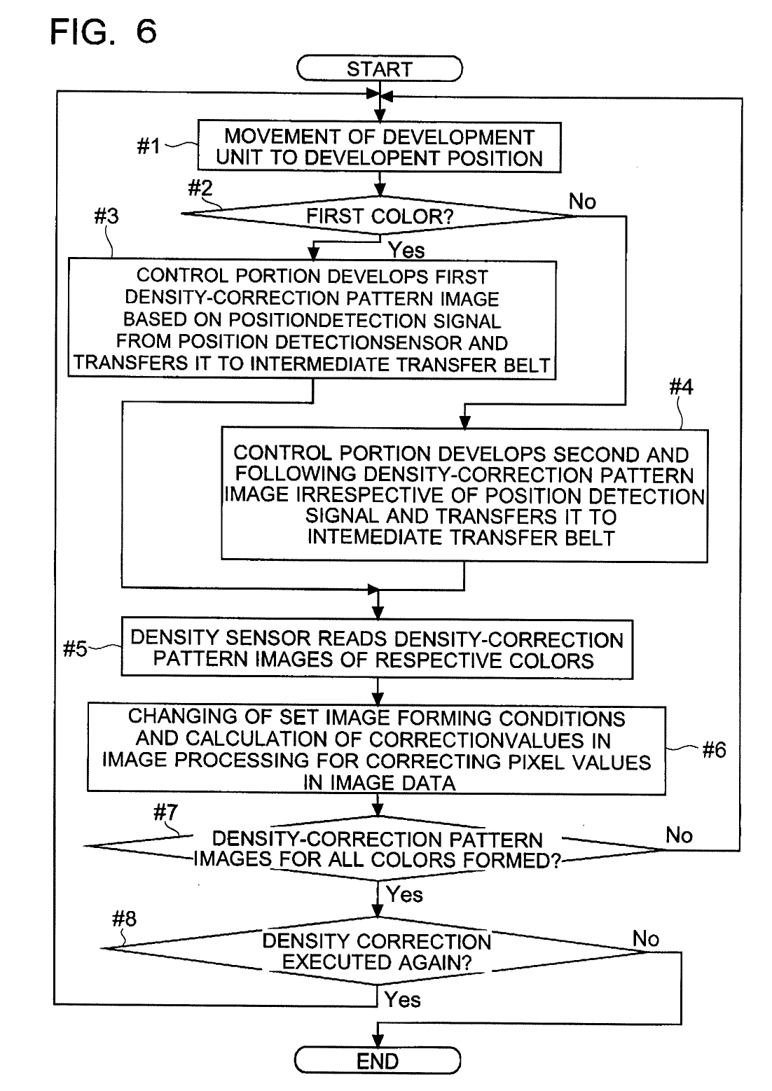

Next, based on FIG. 6, a control example in the time of density correction in the printer 1 according to the first embodiment is explained. FIG. 6 is a flow chart showing an example of a density-correction control flow in the printer 1 according to the first embodiment of the present invention.

At the time of “START” shown in FIG. 6, execution conditions for density correction are already met. In the printer 1 according to the embodiment, density correction is carried out in the following times, for example:
the time of turning on the power supply
the time of returning from a power saving mode (e.g., a sleep mode) into which the printer 1 goes after a predetermined time elapses without carrying out printing
the time the predetermined number (e.g, a few hundreds to a few thousands of paper sheets) of paper sheets are used for printing after the previous density correction (the control portion 9 detects the number of printed paper sheets)
the time a dramatic environmental change (temperature and humidity) is detected
   In the time of density correction, the printer 1 is in a state where printing is impossible, or even when a job (printing) is being executed, the printing job is suspended temporarily.

If the execution conditions for density correction are met, the control portion 9 controls the rotary drive motor M46 of the development portion 44 and moves the development unit 47 (e.g., in the example shown in FIG. 5, the first color is yellow) to the development position (the step #1). Then, it is checked whether or not the first color pattern image PG is formed (the step #2). This is because the formation of the first color pattern image PGY is started using the position detection signal S as a trigger. If it is determined that the first color pattern image PG is formed (Yes in the step #2), the control portion 9 starts the formation of the first color pattern image PGY based on the position detection signal S from the position detection sensor 7, thereby the first color pattern image PG is developed and transferred to the intermediate transfer belt 51 (the step #3).

On the other hand, if it is determined that the second or following pattern image PG is formed (No in the step #2), the control portion 9 forms each color pattern image PG irrespective of the position detection signal S, then the pattern images PG are developed and transferred to the intermediate transfer belt 51 (the step #4). In other words, the control portion 9 forces the image forming portion 4 to form the first color pattern image PG using the position detection signal as a trigger, and to form the second and following pattern images PG irrespective of the position detection signal S. Then, the pattern images PG of the respective colors are read by the density sensor 8 (the step #5).

The CPU 91 of the control portion 9 calculates the density value of an actually formed toner image based on the output value from the density sensor 8, changes image formation conditions (voltages applied to each transfer roller and a voltage value of the development bias and the like), and calculates a correction value used in the image processing for correcting a pixel value contained in the image data (the step #6). Specifically, the control portion 9 adjusts one or more of potentials of: the charged potential of the light-sensitive drum 41 charged by the electrification portion 42; the development bias; and the transfer voltages, or corrects each pixel value contained in the image data, thereby the density correction in the time of printing is performed.

Then, the control portion 9 checks whether or not the formation of all the color pattern images PG is completed (the step #7). In other words, the density correction is carried out for each color. If it is determined that all the color pattern images PG are not formed, the control portion 9 returns to the step #1.

On the other hand, if the formation and measurement of the pattern images PG and the setting for the density adjustment in the time of printing are performed for all the colors, it is checked whether or not the density correction should be performed again (the step #8). The number of repetitions of the density correction may be suitably set, that is, may be so set that the repetition is performed invariably once, or that the repetition is performed only when rechecking is necessary because of presence of more than predetermined level of deviation found between the actual density and the ideal density in the step #5 executed previously. In other words, the control portion 9 is able to perform the control to repeat the density correction a plurality of times (e.g., a few times). It is possible to accurately adjust the density in the time of printing by repeating the density correction a plurality of times. And, in the printer 1 according to the embodiment, because the time required for one density correction is short, the total time for the density correction is nearly equal to the conventional time even if the density correction is repeated a plurality of times.

If it is determined that the density correction should be executed again (Yes in the step #8), the control portion 9 returns to the step #1, and if it is not necessary to execute the density correction again (No in the step #8), the control of the density correction is terminated and the printer 1 comes back to the state in which printing is possible (END).

### Second Embodiment

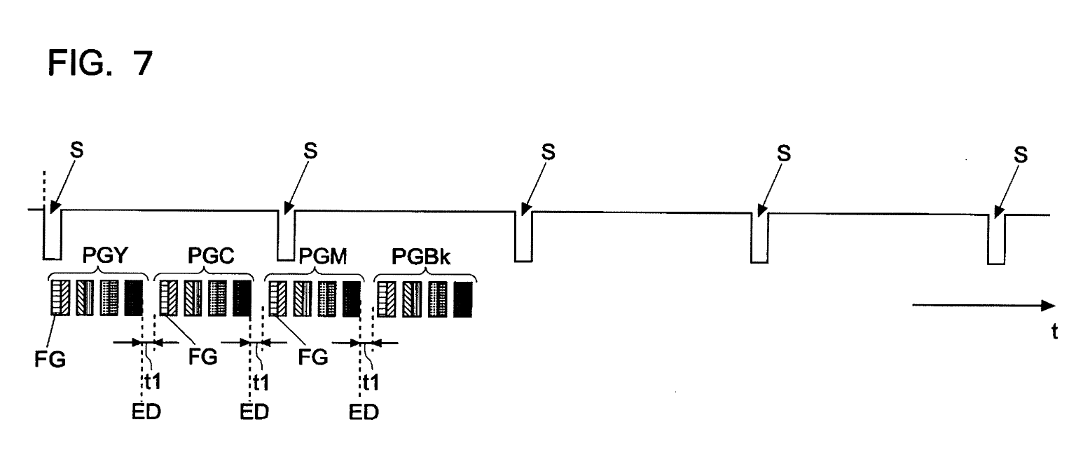

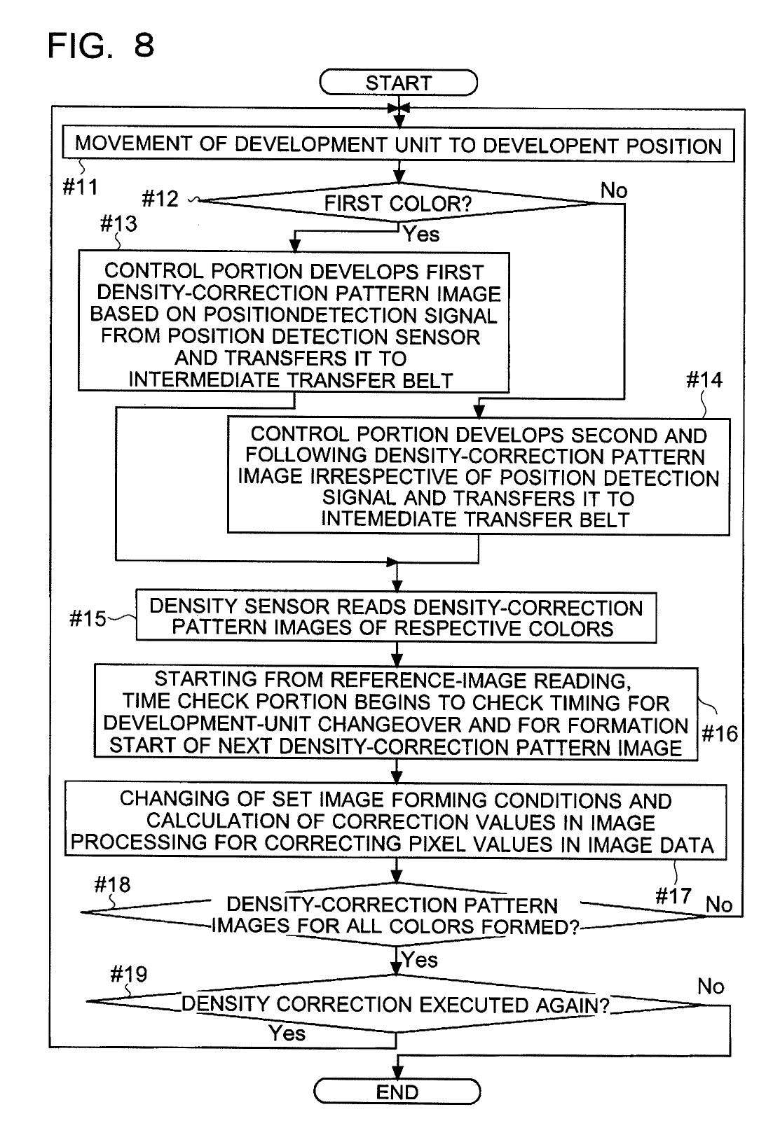

Next, a second embodiment of the present invention is explained based on FIGS. 7 and 8. FIG. 7 is a view to explain timing for formation of the pattern image PG in the printer 1 according to the second embodiment. FIG. 8 is a flow chart showing an example of a density-correction control flow in the printer 1 according to the second embodiment of the present invention.

The second embodiment is identical to the first embodiment in that the printer 1 in the second embodiment forms the first color pattern image PG using the position detection signal S as the trigger and forms the second and following color pattern images PG irrespective of the position detection signal S, but different in that the timing for the next color pattern image PG is controlled when the front image of the pattern image PG previously formed is read or using a reference, that is, a change in the output from the density sensor 8 caused by passage of the trailing edge ED of the pattern image PG. In other respects, because the second embodiment is identical to the first embodiment, explanation and drawings of common points are omitted and common reference numbers are used to indicate common parts.

Specifically, when the front image FG of the preceding pattern images PG is read, or using passage of the trailing edge ED of the pattern image PG as the reference, at least the timing for rotation start of the rotation frame 46 for a changeover of the development unit 47 in the time of forming the following pattern image PG and the timing for formation start of the pattern image PG are controlled.

For example, the output from the density sensor 8 is sampled at constant timings, and based on the quantized output from the density sensor 8, the control portion 9 measures the density value of each image that constitutes the formed pattern image PG. However, if a formation position of the pattern image PG deviates because of rotation fluctuation of the belt drive motor M5, it becomes impossible to accurately obtain the density value of each image that constitutes the pattern image PG. The deviation and error in the formation position of the pattern image PG can influence the formation of the following pattern images PG.

Here, if the density sensor 8 that has been reading the intermediate transfer belt 51 reads the front image FG of each pattern image PG, the output from the density sensor 8 dramatically changes. Also, if the state in which the pattern image PG is read changes to the state in which reading of the intermediate transfer belt 51 is started after passage of the pattern-image trailing edge ED, the output from the density sensor 8 dramatically changes. The control portion 9 (the CPU 91) is able to detect easily these dramatic changes in the output from the density sensor 8. In the embodiment, by using these dramatic changes as the reference, for the formation of the next color pattern image PG, the drive start timing of the rotary drive motor M46 that rotates the rotation frame 46 and the formation start timings (the charging by the electrification portion 42, the exposure by the exposure portion 43, the development bias application by the development portion 44) of the pattern image PG are controlled. Thus, error in the process of the pattern image PG becomes less. In other words, it is possible to accurately form each pattern image PG.

Because the timings for the rotation start of the rotation frame 46 and for the formation start of the next color pattern image PG after the passage detections of the front image FG by the density sensor 8 and of the pattern-image trailing edge ED change depending on the circumferential length and rotation speed of the intermediate transfer belt 51 and the disposed position of the density sensor 8, the timings need to be suitably set, for example, the time check portion 92 checks the timings.

Next, an example of a control flow is explained based on FIG. 8.

The second embodiment is different from the first embodiment in that the steps #11 to #19 in FIG. 8 include the step #16. Because the steps #11 to #15 and the steps #17 to #19 are respectively invariably identical to some of the steps #1 to 8 in the first embodiment except the step #16 and explanation of the identical steps is skipped.

In the added step #16, by using the reference, that is, the read time of a reference image (e.g., the front image or the trailing edge of the pattern image PG) of the images that constitute each pattern image PG, the time check portion 92 begins to check the timings for a changeover of the development unit 47(rotation of the rotation frame 46) and for formation start of the next color pattern image PG. Thus, execution timings of the steps #11 and #14 are determined. In other words, when the output from the density sensor 8 is inputted into the control potion 9 and the front image of the pattern image PG previously formed, or based on a change in the output from the density sensor 8 due to passage of the pattern-image trailing edge ED, the control portion 9 controls the timings and forces the image forming portion 4 to form the following pattern image PG. Besides, based on a change in the output from the density sensor 8 at the time of reading the pattern image PG previously formed, the control portion 9 controls the timing to rotate the rotation frame 46.

Conventionally, in the image forming apparatus (e.g., a printer 1) that uses only one light-sensitive drum 41 and forms a toner image of each color, all the pattern images PG each having one color are formed by using the position detection signal S. However, according to the foregoing first and second embodiments, because the second and following pattern images PG are formed irrespective of the position detection signal S, it is possible to shorten the total time required for the formation of the density-correction pattern images PG of all the colors. Accordingly, the time required for density correction is shortened, and it is possible to shorten the wait time for users and the time the image forming apparatus takes to become ready to print. Besides, producibility of the image forming apparatus also improves.

Besides, the density detector (the density sensor 8)is disposed facing the intermediate transfer member (the intermediate transfer belt 51) so as to detect density of the density-correction pattern image PG, wherein when an output from the density sensor 8 is inputted into the control portion 9 and a front image of the density-correction pattern image PG formed previously is read, or based on a change in the output from the density sensor 8 due to passage of a trailing edge of the density-correction pattern image PG, the control portion 9 controls timing and forces the image forming portion 4 to form a following density-correction pattern image PG. Thus, because the control portion 9 controls the timing based on a change in the output from the density sensor 8 and forces the image forming portion 4 to form the following density-correction pattern image PG, it is possible to reduce deviation in formation position and timing of the density-correction pattern image PG and improve read accuracy with which the density sensor 8 reads the density-correction pattern image PG.

The development portion 44 includes the rotation frame 46 which houses development units 47 each being for one color, and changes the development unit 47 that is used facing the light-sensitive drum 41 by rotation of the rotation frame 46, and when the density sensor 8 reads a front image of the density-correction pattern image PG formed previously, or based on a change in the output from the density sensor 8 due to passage of a trailing edge of the density-correction pattern image PG, the control portion 9 controls timing and forces the rotation frame 46 to rotate. Thus, because the control portion 9 controls the timing based on a change in the output from the density sensor 8 and forces the rotation frame 46 to rotate, it is possible to accurately control the timing for rotating the rotation frame 46, and reduce a deviation in formation position of the density-correction pattern image PG and improve accuracy of the density-correction pattern image PG.

During the time of density correction, the control portion 9 compares a toner-image density value, which is calculated based on an output value from the density sensor 8 that is obtained at the time of reading the density-correction pattern image PG, with an ideal density value. Thus, it is possible to suitably confirm the current toner-image density (the density to the ideal density).

The image processing portion 94 that applies image-data processing to a formed image is included, wherein the control portion 9 carries out density adjustment in a time of printing by forcing the image processing portion 94 to correct each pixel value of image data. The control portion 9 carries out density adjustment in the time of printing by adjusting any one or more of: an electrification potential of the light-sensitive drum 41 charged by the electrification portion 42; a development bias applied to the development roller 48 in the development portion 44 that carries a toner thin layer; and a voltage that the intermediate transfer portion 5 applies in a time of transferring a toner image. Here, a specific example of density adjustment is described, in which because density in the time of printing is adjusted with various approaches so as to become close to an ideal density, thereby maintaining high quality of formed images.

The control portion 9 repeats density correction a plurality of times (e.g., a few times). It is possible to accurately perform density adjustment by repeating density correction. Besides, because the time required for one density correction in the present invention is short, the total time required for density correction hardly changes even if density correction is repeated a plurality of times.

### Third Embodiment

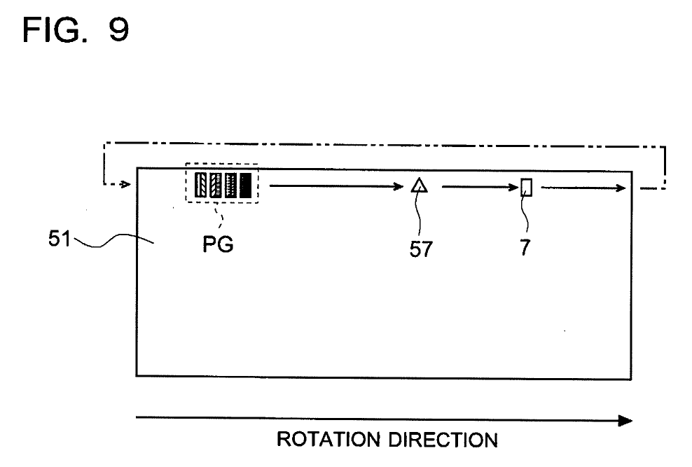

Next, a third embodiment of the present invention is explained based on FIG. 9. FIG. 9 is a developed view of the intermediate transfer belt 51 according to the third embodiment.

The printer 1 according to the third embodiment is in principle identical to the printer 1 according to the first and second embodiments in that the printer 1 in the third embodiment forms the first color pattern image PG using the position detection signal S as the trigger and forms the second and following color pattern images PG irrespective of the position detection signal S, but different in that the position detection sensor (which corresponds to the position detector) functions as the density sensor 8 (which corresponds to the density detector) as well. In other respects, because the third embodiment is identical to the first and second embodiments, explanation and drawings of common points are omitted and common reference numbers are used to indicate common parts.

In FIG. 9, a surface of the intermediate transfer belt 51 is shown. The position confirmation portion 57 is disposed on an edge portion of the intermediate transfer belt 51. The position detection sensor 7 (which corresponds to the position detector) is disposed at a position over the movement path of the position confirmation portion 57. The third embodiment is identical to the first and second embodiments in that the position detection sensor 7 includes a light emitting device such as an LED and the like that directs light to the intermediate transfer belt 51, and a light receiving device such as a photodiode and the like that receives reflected light from the intermediate transfer belt 51.

As shown in FIG. 9, in the time of density correction, the image forming portion 4 of the printer 1 in the embodiment so forms the pattern image PG on an edge portion of the intermediate transfer belt 51 (in FIG. 9, images of only one color are shown) that the pattern image PG passes through the read area of the position detection sensor 7. Like the density sensor 8, because the position detection sensor 7 also includes the light emitting portion 71 and the light receiving portion 72, the output from the position detection sensor 7 in the time the position detection sensor 7 receives reflected light from the surface of the intermediate transfer belt 51 is different from the output in the time position detection sensor 7 receives reflected light from a toner image. In other words, the density sensor 8 is not additionally included, but the position detection sensor 7 serves as the density sensor 8 as well instead. Thus, it is possible to decrease the number of constituent components of the image forming apparatus, thereby reducing cost of the image forming apparatus.

The output from the position detection sensor 7 is inputted into the control portion 9 (see FIG. 4). Output voltages from the position detection sensor 7 that are obtained when the position detection sensor 7 reads the pattern images PG of respective colors that are formed at ideal densities are measured in advance, and the density values equivalent to the output values are stored in the storage portion 93. The CPU 91 compares a density value equivalent to an output voltage that is obtained when an each-density toner image of a pattern image actually formed is read with the density of the ideal-density toner image, thereby a deviation between the density of each-density toner image and the density of the ideal toner image is able to be detected without additionally disposing the density sensor 8.

The embodiments of the present invention are described above. However, the present invention is not limited to the embodiments, and various modifications can be made within the scope not departing from the spirit of the present invention.

What is claimed is:

1. An image forming apparatus, comprising:
an image forming portion that includes: a photoreceptor that carries a toner image; an electrification portion that charges the photoreceptor; an exposure portion that forms an electrostatic latent image by performing scan and exposure of the photoreceptor after electrification; and a development portion which develops a plurality of toner images each having one color by supplying each color toner of a plurality of color toners to the electrostatic latent image;
an intermediate transfer portion that includes an intermediate transfer member which rotates and on which the toner images each having one color and carried on the photoreceptor are primarily transferred with the toner images being overlapped, the intermediate transfer portion secondarily transfers the toner images on a paper sheet;
a position confirmation portion that is disposed on the intermediate transfer member for confirmation of a rotational position of the intermediate transfer member;
a position detector that outputs a position detection signal at a time of passage of the position confirmation portion; and
a control portion into which the position detection signal is inputted and which controls operation of the image forming apparatus, and when forming a density-correction pattern image that is a combination of images which are identical to each other in color and different in density, forces the image forming portion to form the density-correction pattern image of a first color by using the position detection signal as a trigger, and forces the image forming portion to form the density-correction pattern images of a second and following colors irrespective of the position detection signal.

2. The image forming apparatus according to claim 1, further comprising a density detector that is disposed facing the intermediate transfer member so as to detect density of the density-correction pattern image, wherein
when an output from the density detector is inputted into the control portion, and based on a change in output from the density detector when a front image of the density-correction pattern image formed previously is read, the control portion controls timing and forces the image forming portion to form a following density-correction pattern image.

3. The image forming apparatus according to claim 1, further comprising a density detector that is disposed facing the intermediate transfer member so as to detect density of the density-correction pattern image, wherein
when an output from the density detector is inputted into the control portion, and based on a change in output from the density detector due to passage of a trailing edge of the density-correction pattern image, the control portion controls timing and forces the image forming portion to form a following density-correction pattern image.

4. The image forming apparatus according to claim 2, wherein
the development portion includes a rotation frame which houses development units each being for one color, and changes the development unit that is used facing the photoreceptor by rotating the rotation frame, and
based on a change in the output from the density detector when the density detector reads a front image of the density-correction pattern image formed previously, the control portion controls timing and forces the rotation frame to rotate.

5. The image forming apparatus according to claim 3, wherein
the development portion includes a rotation frame which houses development units each being for one color, and changes the development unit that is used facing the photoreceptor by rotating the rotation frame, and
based on a change in the output from the density detector due to passage of a trailing edge of the density-correction pattern image formed previously, the control portion controls timing and forces the rotation frame to rotate.

6. The image forming apparatus according to claim 2, wherein
during a time of density correction, the control portion compares a toner-image density value, which is calculated based on an output value from the density detector that is obtained at the time of reading the density-correction pattern image, with an ideal density value.

7. The image forming apparatus according to claim 3, wherein
during a time of density correction, the control portion compares a toner-image density value, which is calculated based on an output value from the density detector that is obtained at the time of reading the density-correction pattern image, with an ideal density value.

8. The image forming apparatus according to claim 6, further comprising an image processing portion that applies image-data processing to a formed image, wherein
the control portion carries out density adjustment in a time of printing by forcing the image processing portion to correct each pixel value of image data.

9. The image forming apparatus according to claim 7, further comprising an image processing portion that applies image-data processing to a formed image, wherein
the control portion carries out density adjustment in a time of printing by forcing the image processing portion to correct each pixel value of image data.

10. The image forming apparatus according to claim 6, wherein
the control portion carries out density adjustment in a time of printing by adjusting any one or more of: an electrification potential of the photoreceptor charged by the electrification portion; a development bias applied to a development roller that carries a toner thin layer; and a voltage that the intermediate transfer portion applies in a time of transferring a toner image.

11. The image forming apparatus according to claim 7, wherein
the control portion carries out density adjustment in a time of printing by adjusting any one or more of: an electrification potential of the photoreceptor charged by the electrification portion; a development bias applied to a development roller that carries a toner thin layer; and a voltage that the intermediate transfer portion applies in a time of transferring a toner image.

12. The image forming apparatus according to claim 2, wherein
the control portion repeats density correction a plurality of times.

13. The image forming apparatus according to claim 3, wherein
the control portion repeats density correction a plurality of times.

14. The image forming apparatus according to claim 2, wherein
the density detector is not additionally included, but the position detector serves as the density detector as well instead.

15. The image forming apparatus according to claim 3, wherein
the density detector is not additionally included, but the position detector serves as the density detector as well instead.
